(19) United States
(12) Patent Application Publication
(10) Pub. No.: US 2013/0301949 A1
(43) Pub. Date: Nov. 14, 2013

(54) IMAGE ENHANCEMENT APPARATUS AND METHOD

(71) Applicant: SONY CORPORATION, Tokyo (JP)

(72) Inventors: Paul Springer, Stuttgart (DE); Toru Nishi, Tokyo (JP); Matthias Bruggemann, Bueren (DE)

(73) Assignee: Sony Corporation, Tokyo (JP)

(21) Appl. No.: 13/886,807

(22) Filed: May 3, 2013

(30) Foreign Application Priority Data
May 11, 2012 (EP) 12167633.2

(51) Int. Cl. G06T 5/00

(52) U.S. Cl. CPC G06T 5/00
USPC 382/255

(57) ABSTRACT

An image enhancement apparatus for enhancing an input image of a sequence of input images of at least a first view and obtaining an enhanced output image of at least said first view comprises an unsharp masking unit configured to enhance the sharpness of the input image, a motion compensation unit configured to generate at least one preceding motion compensated image by compensating motion in a preceding output image, a weighted selection unit configured to generate a weighted selection image from said sharpness enhanced input image and said preceding motion compensated image based on selection weighting factor, a detail signal generation unit configured to generate a detail signal from said input image and said weighted selection image, and a combination unit configured to generate said enhanced output image from said detail signal and from said input image and/or said weighted selection image.

### CROSS-REFERENCE TO RELATED APPLICATION

The present application claims priority to European Patent Application 12 167 633.2, filed in the European Patent Office on May 11, 2012, the entire contents of which being incorporated herein by reference.

### BACKGROUND

1. Field of the Disclosure

The present disclosure relates to an image enhancement apparatus and a corresponding method for enhancing an input image of a sequence of input images of at least a first view and obtaining an enhanced output image of at least said first view. Further, the present disclosure relates to a display device, a computer program and a computer readable non-transitory medium

2. Description of Related Art

Super-resolution can enhance the resolution in images and video sequences. The specific characteristic of super-resolution is that it is able to create high resolution frames which have high spatial frequencies not present in each low resolution input frame.

In M. Tanaka and M. Okutomi, “Toward Robust Reconstruction-Based Super-Resolution,” in Super-Resolution Imaging, P. Milanfar, Ed. Boca Raton: CRC Press, 2011, pp. 219-244 a system for generating a high resolution output sequence from multiple input frames is presented, accumulating details from a number of available input frames, which are all available as input of the system. The output signal is assumed to have a higher pixel range than the input signal. Therefore an internal up- and down sampling is necessary.

In US 2010/0119176 A1 a system for generating a high resolution output sequence from a sequence with lower spatial resolution is presented. The system uses a temporal recursive super-resolution system in parallel to a spatial upscaling system. As the output signal has a higher pixel range than the input signal, an internal upsampling is used. The higher detail level is achieved by temporally accumulating details from multiple temporal instances from the input sequence using a recursive feedback loop.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present invention.

### SUMMARY

It is an object to provide an image enhancement apparatus and a corresponding image enhancement method for enhancing an input image of a sequence of input images of at least a first view and obtaining an enhanced output image of at least said first view, which particularly provide an image detail and sharpness enhancement for monoscopic as well as stereoscopic input sequences and avoid the generation of additional artifacts and noise. It is a further object to provide a corresponding computer program for implementing said method and a computer readable non-transitory medium.

According to an aspect there is provided an image enhancement apparatus for enhancing an input image of a sequence of input images of at least a first view and obtaining an enhanced output image of at least said first view, said apparatus comprising:

an unsharp masking unit configured to enhance the sharpness of the input image,

a motion compensation unit configured to generate at least one preceding motion compensated image by compensating motion in a preceding output image,

a weighted selection unit configured to generate a weighted selection image from said sharpness enhanced input image and said preceding motion compensated image based on selection weighting factor,

a detail signal generation unit configured to generate a detail signal from said input image and said weighted selection image, and

a combination unit configured to generate said enhanced output image from said detail signal and from said input image and/or said weighted selection image.

According to a further aspect there is provided an image enhancement apparatus for enhancing an input image of a sequence of input images of at least a first view and obtaining an enhanced output image of at least said first view, said apparatus comprising:

an unsharp masking means for enhancing the sharpness of the input image,

a motion compensation means for generating at least one preceding motion compensated image by compensating motion in a preceding output image,

a weighted selection means for generating a weighted selection image from said sharpness enhanced input image and said preceding motion compensated image based on selection weighting factor,

a detail signal generation means for generating a detail signal from said input image and said weighted selection image, and

a combination means for generating said enhanced output image from said detail signal and from said input image and/or said weighted selection image.

According to still further aspects a corresponding image enhancement method, a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Preferred embodiments are defined in the dependent claims. It shall be understood that the claimed image enhancement method, the claimed computer program and the claimed computer-readable recording medium have similar and/or identical preferred embodiments as the claimed image enhancement apparatus and as defined in the dependent claims.

One of the aspects of the disclosure is to provide a solution for image detail and sharpness enhancement for monoscopic as well as stereoscopic input sequences, particularly in current and future display devices, such as TV sets, which solution avoids the generation of additional artifacts and noise. Information from two or more input frames from left and/or right view is used to generate an output signal with additional details and a perceived higher resolution and sharpness. Recursive processing allows keeping the required frame memory to a minimum (e.g. one additional frame buffer for each view), although information from two or more input frames is used. The provided apparatus and method are thus computationally efficient, require only a small storage resulting in cheap hardware costs and a high image or video output quality robust towards motion estimation errors and other side-effects.

The provided apparatus and method are able to handle different input and output scenarios including a) single view input, single view output, b) stereo input, single view output, and c) stereo input, stereo output. In case of stereo input, the details from multiple temporal instances of both views are accumulated, generating a monoscopic or stereoscopic output sequence with additional details.

In contrast to known solutions the provided apparatus and method temporally accumulates details from one or two available input frames at each temporal instance using a recursive temporal feedback loop. Further, no internal up- and down-sampling is required as input and output signal generally have the same pixel range. Still further, provided solution is able to handle also stereoscopic input. A complete spatial processing in parallel for stabilization is generally not necessary.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a general layout of an image enhancement apparatus according to the present disclosure,

FIG. 2 shows a first embodiment of a provided image enhancement apparatus for 2D to 2D processing,

FIG. 3 shows a second embodiment of a provided image enhancement apparatus for 2D to 2D processing,

FIG. 4 shows a third embodiment of a provided image enhancement apparatus for 3D to 2D processing,

FIG. 5 shows a fourth embodiment of a provided image enhancement apparatus for 3D to 3D processing,

FIG. 6 shows an embodiment of an unsharp masking unit,

FIG. 7 shows an embodiment of a weighted selection unit,

FIG. 8 shows an embodiment of image model unit,

FIG. 9 shows an embodiment of a maximum local gradient unit,

FIG. 10 shows an embodiment of a data model unit,

FIG. 11 illustrates an embodiment of an adaptive low-pass filter unit,

FIG. 12 illustrates an embodiment of a difference signal weighting unit,

FIG. 13 shows a fifth embodiment of a provided image enhancement apparatus for 3D to 2D processing and

FIG. 14 shows a sixth embodiment of a provided image enhancement apparatus for 2D to 2D processing.

### DETAILED DESCRIPTION OF THE EMBODIMENTS

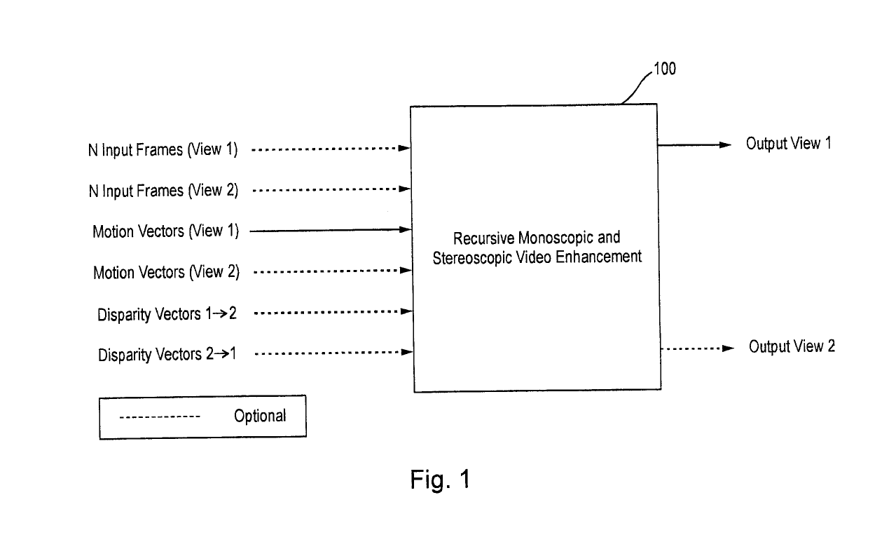

Referring now to the drawings, wherein like reference numerals designate identical or corresponding parts throughout the several views, FIG. 1 schematically depicts the various embodiments of the proposed image enhancement apparatus 100. An image enhancement is carried out on an image sequence, which can be either a single view image sequence or a stereo 3D image sequence. There are at least three possible embodiments (the optional paths in FIG. 1 are shown with dashed lines):

In 2D to 2D processing the image enhancement is carried out on a single view input sequence, using information from multiple input frames from the input view to generate an output signal with a higher perceived resolution. For detecting corresponding pixel positions in the different input frames, preferably sub-pixel precise motion vectors by use of a preceding motion estimation are used.

In 3D to 2D processing the image enhancement is carried out on the input sequence of view 1, using information from multiple input frames of the input sequences of view 1 and view 2 to generate an output signal for view 1 with a higher perceived resolution. For detecting corresponding pixel positions in the different input frames from the different input views, intra-view motion vectors (from view 1) and inter-view disparity vectors (between view 1 and view 2) are used. The preferably sub-pixel accurate motion and disparity vectors are preferably previously detected by use of a motion estimation and a disparity estimation.

In 3D to 3D processing the image enhancement is carried out on the stepreo 3D input sequence, using information from multiple input frames from both input views, to generate output signals for view 1 and view 2 with higher perceived resolutions. For detecting corresponding pixel positions in the different input frames from the different input views, intra-view motion vectors (from view 1 and view 2) and inter-view disparity vectors (between view 1 and view 2 and between view 2 and view 1) are used. The preferably sub-pixel accurate motion and disparity vectors are preferably previously detected by use of a motion estimation and a disparity estimation.

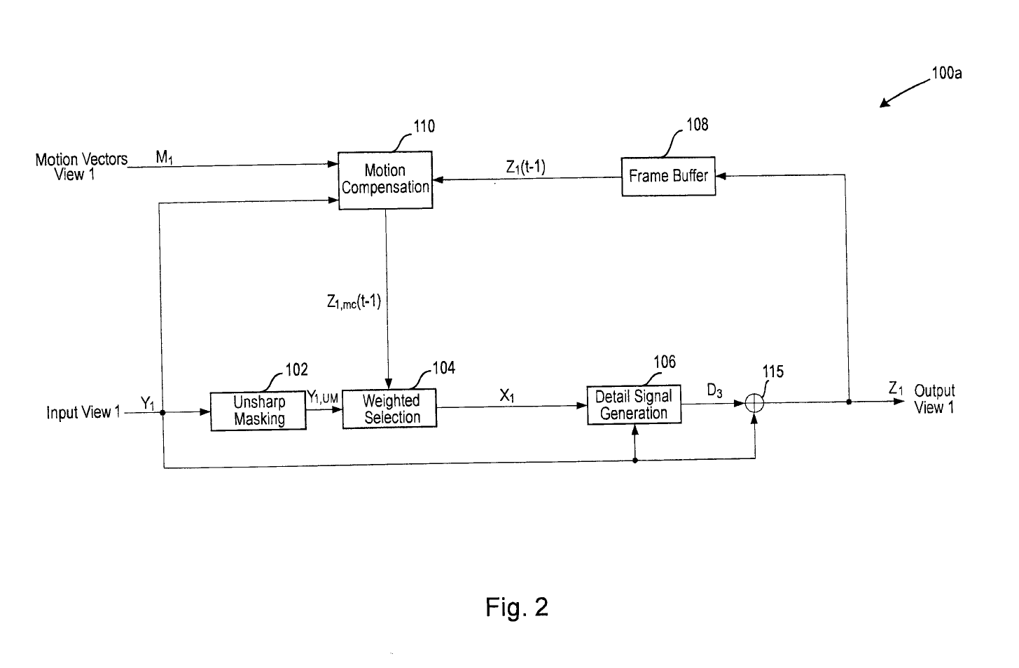

FIG. 2 schematically depicts a first embodiment of the image enhancement apparatus 100a according to the present disclosure for 2D to 2D processing. In an unsharp masking unit 102 an unsharp masking is carried out on the current input frame Y₁ from input view 1 to enhance the sharpness in the input frame Y₁ and approximate the output sharpness of the final result Z₁. The output of this unsharp masking is defined as Y_{1,UM}. Furthermore the result from processing the previous frame Z₁ (t-1), which was stored to a frame buffer 108, is motion compensated in a motion compensation unit 110 using the motion vectors M₁ of view 1. Image positions for which no information from Z₁(t-1) are available are filled using information from Y₁. The compensated previous result is defined as Z_{1,mc}(t-1).

A weighted selection unit 104 computes the reliability of the motion compensation by comparing Z_{1,mc}(t-1) and Y_{1,UM} and mixes the inputs depending on the computed reliability. In case of a high reliability Z_{1,mc}(t-1) is mainly forwarded and in case of a low reliability Y_{1,UM} is mainly forwarded to avoid artifacts from erroneous motion compensation which is caused by bad motion vectors.

The output of the weighted selection unit 104 is defined as X₁. Based on X₁ a detail signal D₃ is computed using a detail signal generation unit 106. The detail signal generation unit 106, which preferably comprises at least a data model unit, generates the detail signal D₃ by comparing X₁ and the available current input frames. In case of only one available view as in the present embodiment, only the current input frame Y₁ from view 1 and the weighted selection image X₁ of the weighted selection unit 104 are used to generate the detail signal D₃.

The resulting detail signal D₃ is combined with Y₁ in a combination unit 115, in this embodiment an addition unit, generating a signal with additional details which is used as the final output signal Z₁ in this embodiment.

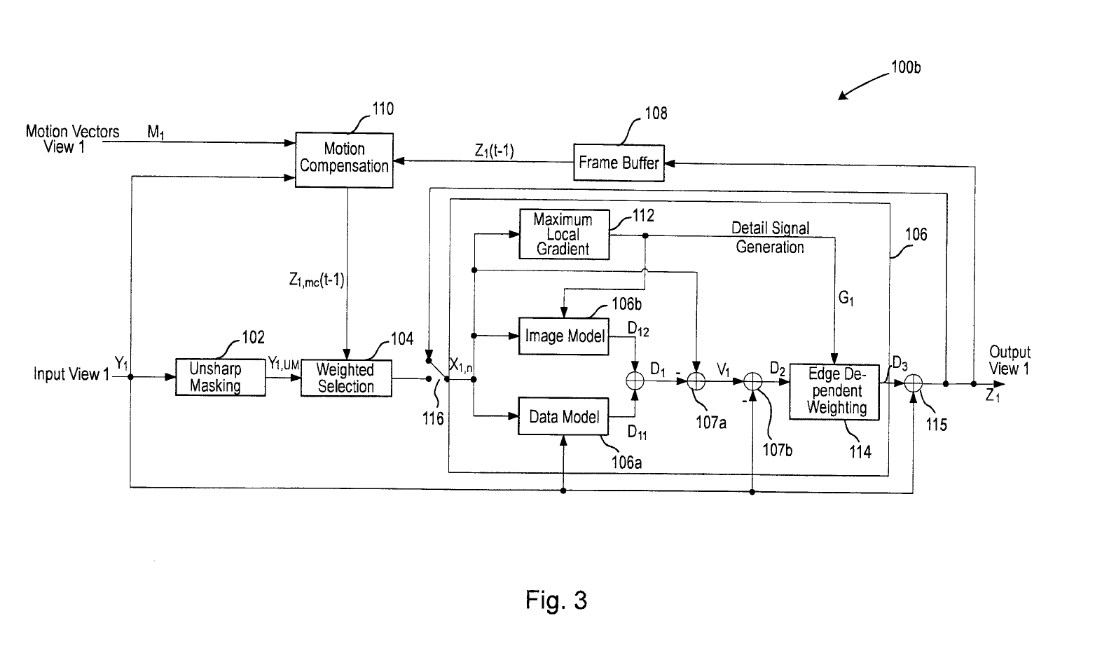

FIG. 3 schematically depicts a second embodiment of the image enhancement apparatus 100b according to the present disclosure for 2D to 2D processing. Compared to the first embodiment of the image enhancement apparatus 100a the detail signal generation unit 106 comprises a data model unit 106a and an image model unit 106b. Thus, based on the output X_{1,n} of the weighted selection unit 104 a detail signal D₂ is computed using a combination of data model and image model processing. The data model unit 106a generates a first detail signal D₁₁ by comparing X_{1,n} and the available current input frames. The image model unit 106b generates a second detail signal D₁₂ using only spatial processing by approximating an image model to reduce spatial artifacts and noise which can be present in X_{1,n}.

The two resulting detail signals D₁₁, D₁₂ are added resulting in a combined detail signal D₁ and then subtracted in a first subtraction unit 107a from X_{1,n}, generating an intermediate signal V₁ with additional details. To generate a final difference signal D₂ between the current input Y₁ and the current result V₁ of the processing, Y₁ is subtracted from V₁ in a second subtraction unit 107b resulting in a final difference signal D₂.

As in edge areas the processing should be reduced to avoid overenhancement, the final difference signal D₂ is weighted with an edge strength dependent weighting factor in an edge dependent weighting unit 114. This weighting factor is based on the maximum local gradient G₁ of X_{1,n} obtained in a maximum local gradient unit 112. The weighted final difference signal D₃ is finally added by an addition unit 115 to the current input signal Y₁, generating the final result Z₁.

To further approximate a super-resolved solution, optionally Z₁ can be internally fed back (set to X_{1,n+1}) using a switch 116 controlling the image model and data model input, allowing multiple iterations of image model and data model processing. In a first iteration the switch 116 couples the output of the weighted selection unit 104 to the subsequent element 106a, 106b, 112. In subsequent iterations the switch 116 couples the output signal Z₁ to said subsequent elements 106a, 106b, 112. To realize a temporally recursive processing, the final result of the image enhancement apparatus 100b is stored to the frame buffer 108, so that in the temporally next processing step the results can be further enhanced. Hence, with the proposed embodiment 100b it is possible to accumulate the details from multiple input frames from two views, using one recursive feedback loop.

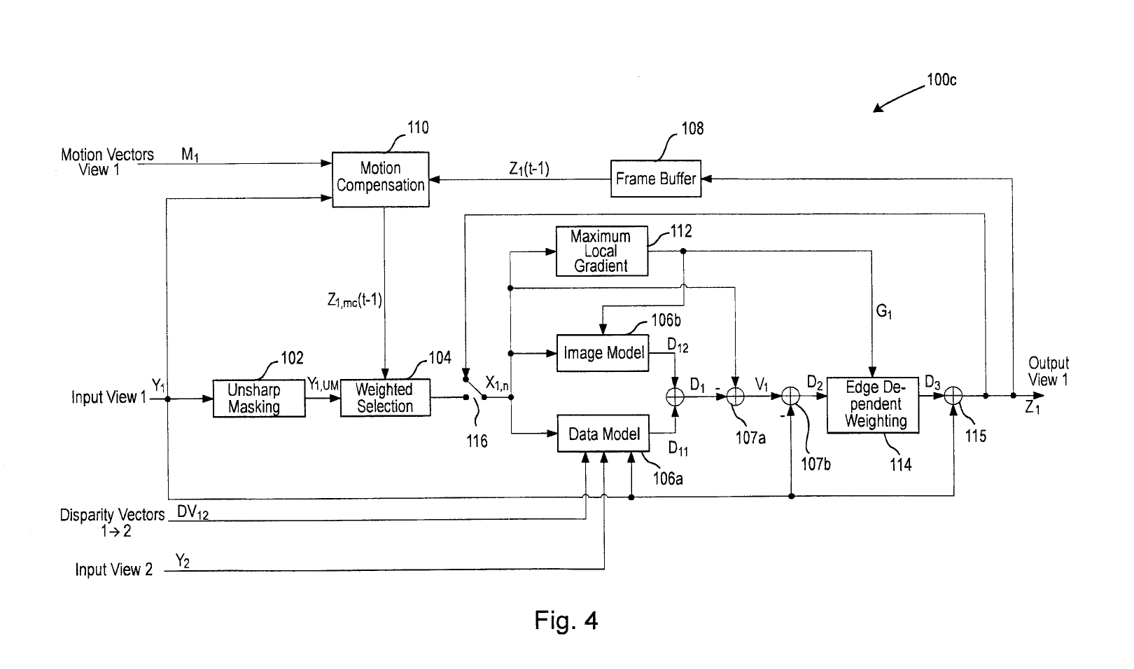

FIG. 4 schematically depicts a third embodiment of the image enhancement apparatus 100c according to the present disclosure for 3D to 2D processing. This embodiment 100c is based on the second embodiment 100b. Compared to the second embodiment 100b input frames Y₂ of an additional input view (view 2) is available. Further, disparity vectors DV₁₂ from view 1 to view 2 with sub-pixel accuracy are available. In the data model unit 106a the current input frames Y₁ from view 1 and the current input frames Y₂ from view 2 are used to generate the detail signal D₁₁. As it is necessary to compensate the disparity shift between view 1 and view 2 the disparity vectors DV₁₂ from view 1 to view 2 are used in addition.

The third embodiment 100c is based on the second embodiment 100b, but in still another embodiment it can also be based on the first embodiment 100a, i.e. in the first embodiment input frames of a second view and disparity vectors from view 1 to view 2 may be available to provide another embodiment of the image enhancement apparatus.

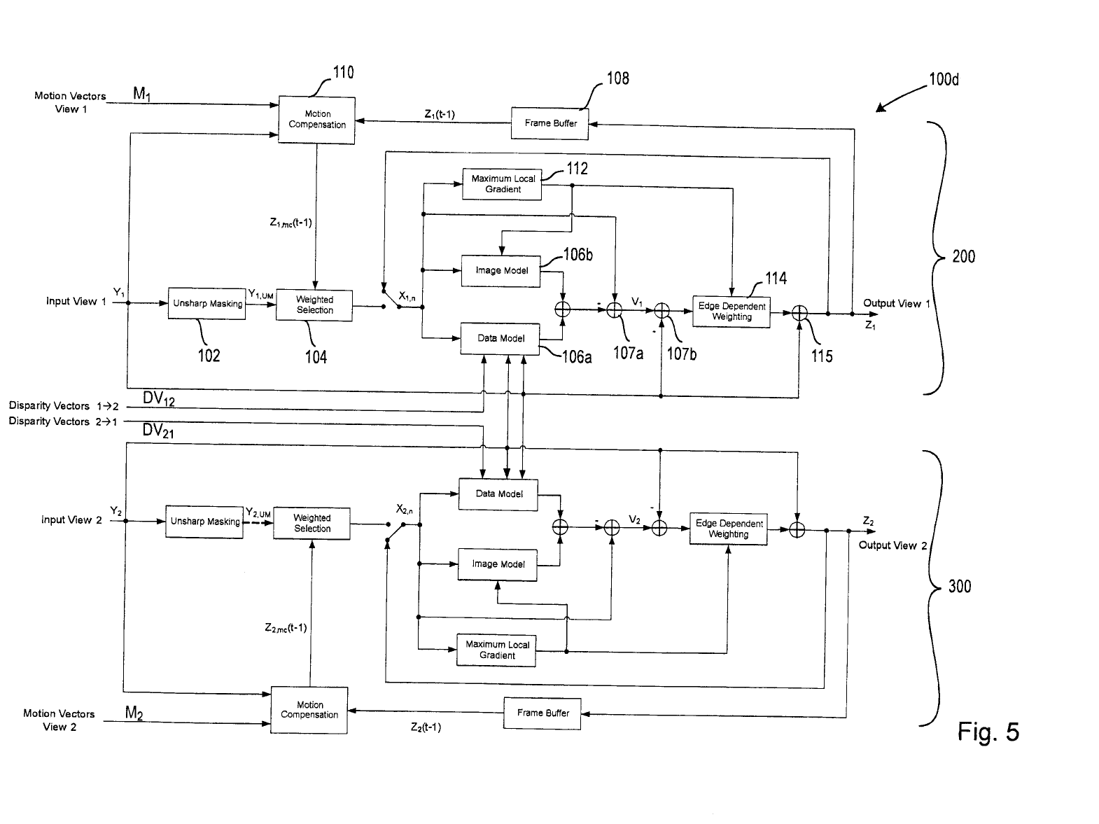

FIG. 5 schematically depicts a fourth embodiment of the image enhancement apparatus 100d according to the present disclosure for 3D to 3D processing. It comprises two (preferably identical) image enhancement apparatus 200 and 300 for parallel processing of input images from two different views. This embodiment 100d is based on the third embodiment 100c. Compared to the third embodiment 100c the described processing steps are computed in parallel for view 1 and view 2. Further, additionally motion vectors M₂ for view 2 and disparity vectors DV₂₁ from view 2 to view 1 are needed. Finally, two output signals Z₁ and Z₂ for the two views are obtained.

The fourth embodiment 100d is based on the third embodiment 100c, but in still another embodiment it can also be based on the first embodiment 100a, i.e. the first embodiment 100a may be doubled (one for each view), and motion vectors and disparity vectors may be added, to provide another embodiment of the image enhancement apparatus.

Exemplary embodiments of the various elements of the above described embodiments of the proposed image enhancement apparatus are described in the following.

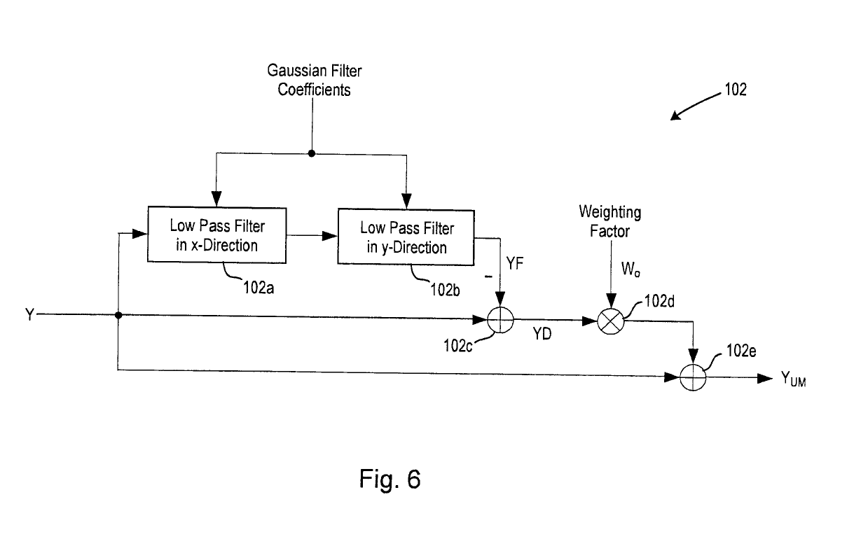

An embodiment of the unsharp masking unit 102 is depicted in FIG. 6. It enhances the sharpness of the input signal Y. In a first step Y is low-pass filtered using a Gaussian low pass filter kernel with given (Gaussian) filter coefficients. The filtering is processed separately in x- and y-direction by a first filter 102a, 102b. The low pass filtered signal YF is then subtracted from Y in a subtraction unit 102c, generating a high frequency detail YD signal of Y. This detail signal YD is multiplied in a multiplication unit 102d with a given weighting factor W₀ and added to the input signal Y in an addition unit 102e, generating an output signal Y_{UM} with amplified high frequencies, which is perceived as a higher sharpness.

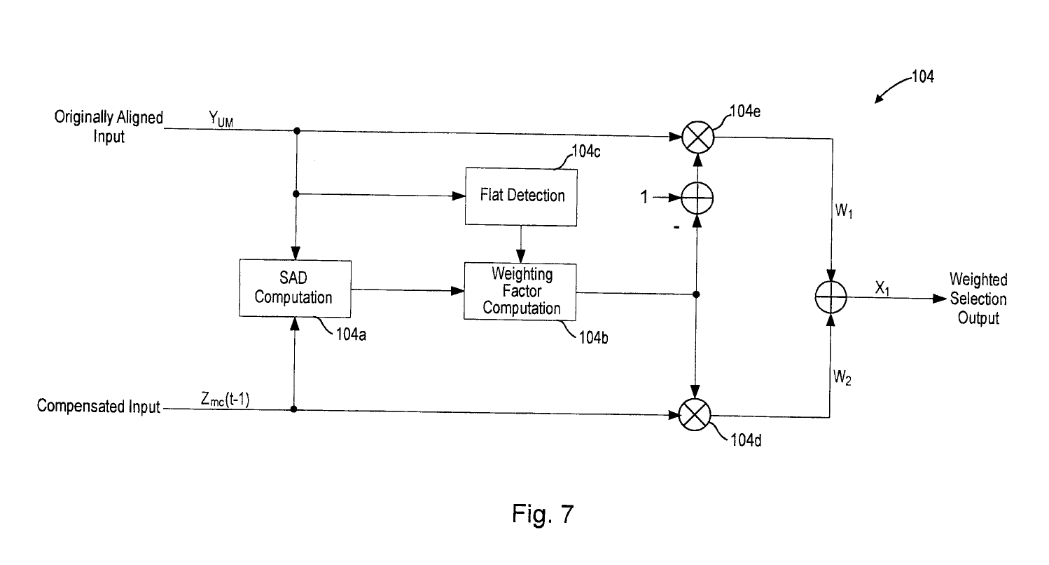

An embodiment of the weighted selection unit 104 is depicted in FIG. 7. It computes a combined signal from two inputs, an originally aligned input and a compensated input. The weighted selection unit 104 combines the originally aligned input Y_{UM} and the compensated Z_{mc}(t-1). Further, in case of an available second view such a weighted selection unit may be used to combine the originally aligned input of the currently processed view and the disparity compensated second view inside the detail signal generation unit 106 (in particular, the data model unit 106a). In case of reliable motion/disparity vectors (which can be obtained from e.g. a SAD computation in an SAD computation unit 104a) the compensated input shall be stronger weighted than the originally aligned input and in case of unreliable motion vectors the originally aligned input shall be stronger weighted to avoid a strong influence of motion vector errors on the output.

The selection weighting factor SW is computed in a weighting factor computation unit 104b based on the local summed absolute difference (SAD), which is computed inside a local block area, e.g. a 3×3 block area. A high SAD describes a strong local difference between the originally aligned input and the compensated input, which indicates a motion vector error. This assumption does not consider that in flat areas motion vector errors result in smaller differences between originally aligned input and compensated input than in textured areas. Therefore also a flat detection unit 104c is utilized for the computation of the weighting factor, allowing bigger differences in detail areas than in flat areas for strongly weighting the compensated input. This results in the following equation for the weighting factor computation:

$$weightingFactor = \frac{{λ}_{temp} + {λ}_{temp , adapt} \cdot flatMap}{1 + S A D} \qquad ( 1 )$$

Here, λₜₑₘₚ and λ_{temp,adapt} are predefined control parameters.

For computation of the output of the weighted selection unit 104, the compensated input is multiplied in a multiplication unit 104d with the weighting factor and the originally aligned input is multiplied in a multiplication unit 104e with one minus the weighting factor. The resulting weighted signals W₁, W₂ are then summed up and used as the output signal X₁ of the weighted selection unit 104.

For the flat map computation in the flat detection unit 104c the absolute local Laplacian is computed in an embodiment and summed up over a block area, e.g. 5×5 block area. Between a lower and an upper threshold the computed sum is mapped to values between 0 (flat area) and 1 (texture area).

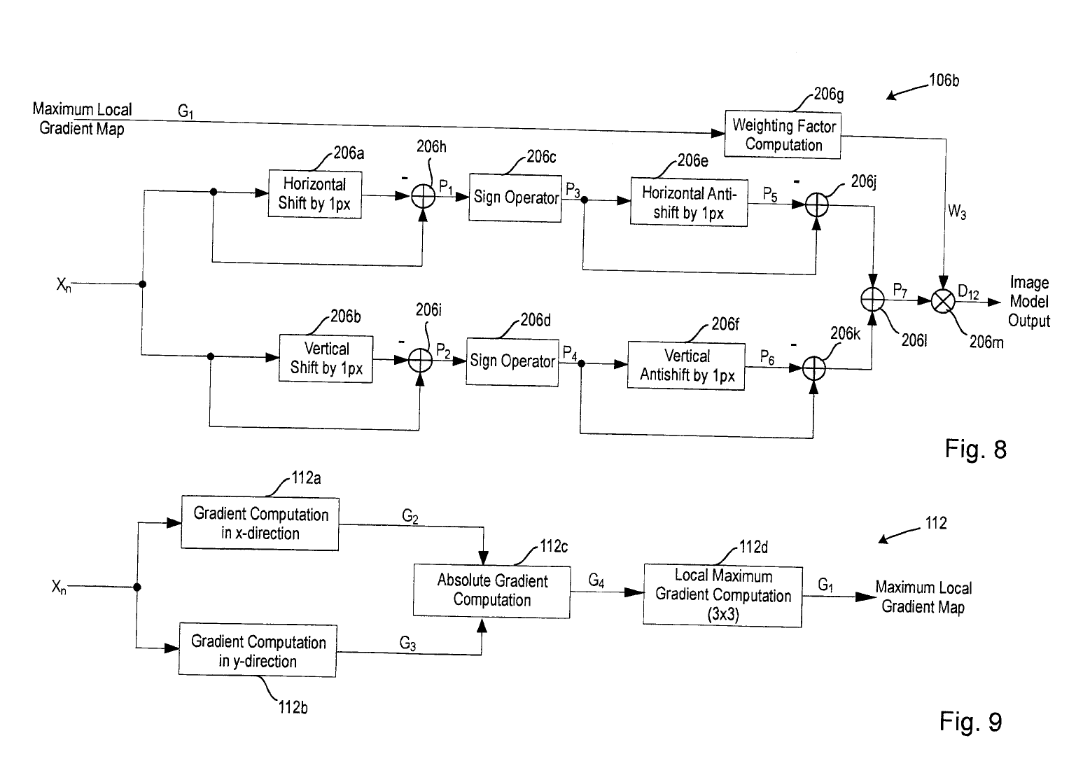

The embodiment of the image model unit 106b depicted in FIG. 8 generates a detail signal based on Xₙ. When this detail signal is subtracted from the input signal, variations are reduced, approximating the total variation image model, which models an image as a combination of flat areas divided by steep edges. To generate the detail signal, Xₙ, is shifted by 1 pixel in horizontal and vertical direction by a horizontal shift unit 206a and a vertical shift unit 206b, respectively. The shifted images are subtracted in a first subtraction unit 206h, 206i from Xₙ, generating a map P₁, P₂ with gradients in horizontal and vertical directions. After this a sign operator 206c, 206d is applied to the gradient maps P₁, P₂, resulting in +1 for positive gradients and −1 for negative gradients. The resulting maps P₃, P₄ are then shifted back by 1 pixel in horizontal and vertical direction by a horizontal anti-shift unit 206e and a vertical anti-shift unit 206f, respectively. The back shifted maps P₅, P₆ are subtracted in a second subtraction unit 206j, 206k from the outputs of the sign operators 206c, 206d and added together in an addition unit 206l. Finally the resulting detail signal P₇ is multiplied in a multiplication unit 206m with an adaptive weighting factor W₃ which depends on the maximum local gradient map G₁ and is computed by a weighting factor computation unit 206g resulting in the output D₁₂.

The weighting factor W₃ is selected based on several gradient thresholds and a given image model weight:

$$weightingFactor = \{ \begin{matrix}IM Weight \cdot 0.3 & for max Grad < Thr 1 \\ IM Weight \cdot 0.75 & for Thr 1 \leq max Grad < Thr 2 \\ IM Weight \cdot 1 & for Thr 2 \leq max Grad < Thr 3 \\ IM Weight \cdot 2 & for max Grad \geq Thr 3\end{matrix} \qquad ( 2 )$$

FIG. 9 depicts an embodiment of the maximum local gradient unit 112. In a first step the gradients G₂, G₃ of Xₙ in x and y direction are computed in gradient calculation units 112a, 112b by simple difference operators:

gradX(x,y)=Xₙ(x,y)−Xₙ(x−1,y)

gradY(x,y)=Xₙ(x,y)−Xₙ(x,y−1) (3)

Then the absolute gradient G₄ is computed in an absolute gradient computation unit 112c by the following operation:

gradient=\sqrt{gradX²+gradY²} (4)

Finally the maximum local gradient G₁ is detected inside a local block area, e.g. a 3×3 block area, by a local maximum gradient computation unit 112d and written to the maximum local gradient map. This map describes the local edge strength in X.

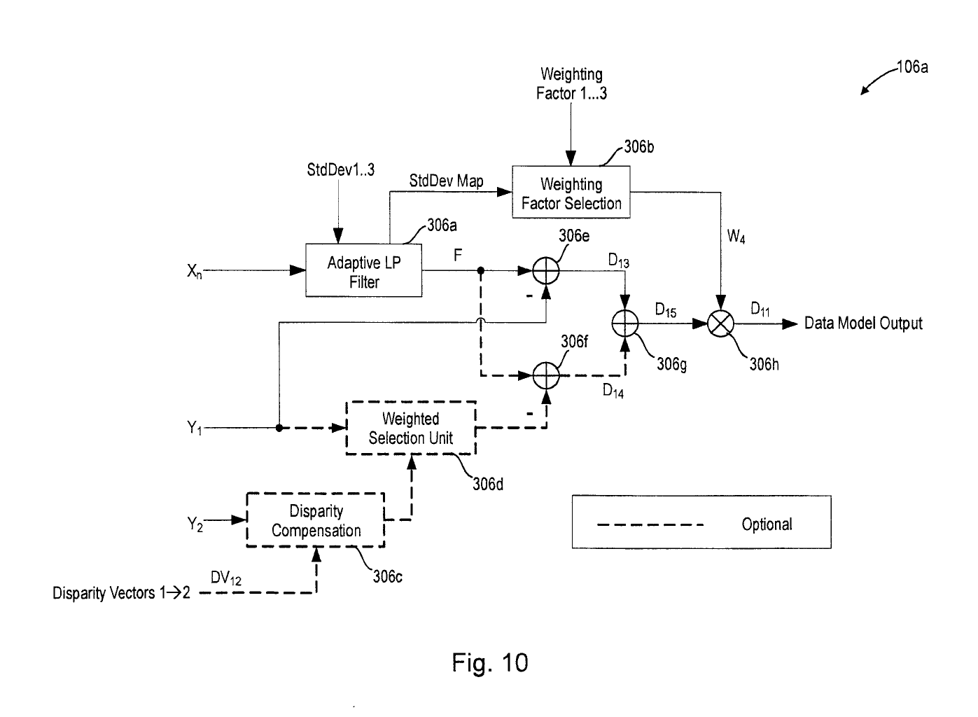

The embodiment of the data model unit 106a depicted in FIG. 10 generates a detail signal D₁₁ from the available input frames by computing a difference signal between the input signal and the blurred Xₙ, which is ideally the (compensated) result of the previous temporal or internal iteration. To blur Xₙ, the signal is low-pass filtered into signal F using an adaptive low-pass filter 306a which is described below. In case of only one available view, the current input signal Y1 is subtracted from the low-pass filtered Xₙ in a subtraction unit 306e resulting in a detail signal D₁₃. In case of an available second view an additional detail signal D₁₄ is generated in a subtraction unit 306f and added to the first detail signal D₁₃ in an adder 306g. The resulting detail signal D₁₅ is multiplied in a multiplier 306h with an adaptive weighting factor W₄, which is selected by a weighting factor selection unit 306b depending on the locally used standard deviation for adaptive filtering.

To generate the detail signal D₁₄ based on view 2, at first the disparity shift compared to view 1 has to be compensated, using a disparity compensation unit 306c with sub-pixel accuracy. After that the compensated Y2 is mixed with Y1 using the weighted selection unit 306d, which can be built in the same manner as the weighted selection unit 104 depicted in FIG. 7, to eliminate artifacts from erroneous disparity compensation and realize a higher robustness against disparity vector errors.

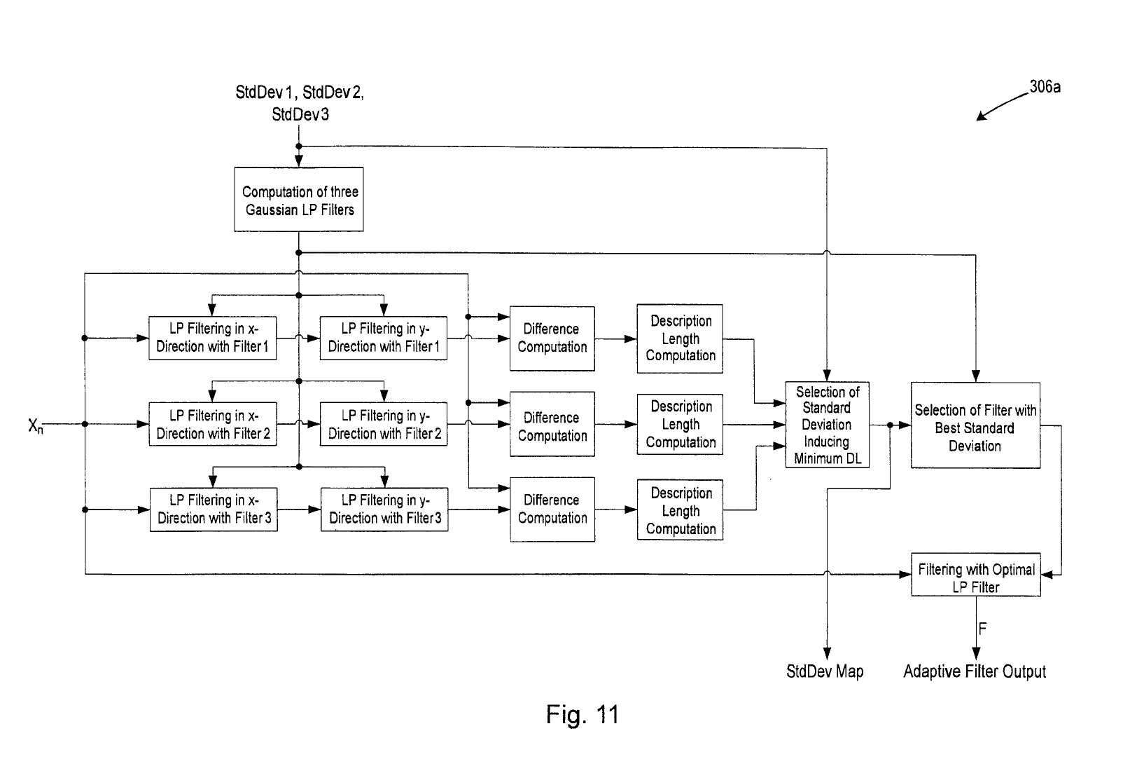

Inside the data model unit 106a an adaptive low-pass filter 306a is used, an embodiment of which is depicted in FIG. 11. Gaussian filters are used for filtering. The optimal standard deviation (StdDev) for estimation is computed depending on a minimum description length criterion. To realize this, the input signal Xₙ is separately filtered with three different 7-tap Gaussian filter kernels, which are computed using three different standard deviations σₓ:

$${Filter}_{x} ( i ) = {e}^{- \frac{{i}^{2}}{2 {σ}_{x}^{2}}} , i = - 3 … 3 \qquad ( 5 )$$

For filtering the input image is separately convoluted with the filter coefficients in horizontal and vertical direction:

$$\begin{matrix}{I}_{Filter , hor} ( x , y ) = \frac{{\sum }_{i = - 3 … 3} {Filter}_{x} ( i ) \cdot {X}_{n} ( x + i , y )}{{\sum }_{i = - 3 … 3} {Filter}_{x} ( i )} , & ( 6 ) \\ {I}_{Filter , vert} ( x , y ) = \frac{{\sum }_{i = - 3 … 3} {Filter}_{x} ( i ) \cdot {I}_{Filter , hor} ( x , y + i )}{{\sum }_{i = - 3 … 3} {Filter}_{x} ( i )} & ( 7 )\end{matrix}$$

Then the difference images between the low-pass filtered results and Xₙ are computed. For each filtered image then the local description length is computed inside a 5×5 block area using the following equation.

$${dl}_{x} = ( \frac{λ}{{σ}_{x}^{2}} ) + {σ}_{x} \cdot {\sum }_{5 \times 5 Block} {diff}^{ 2} / 25 , \\ λ = 48 ( heuristically chosen ) \qquad ( 8 )$$

The local description length values are used to detect the standard deviation of the low-pass filters that induce the local minimum description length. Finally Xₙ is adaptively filtered using the locally optimal filter kernel. The 2D Filter is computed by:

$$Filter ( i , j ) = {e}^{- \frac{{i}^{2} + {j}^{2}}{2 {σ}_{opt}^{2}}} , \\ i = - 3 … 3 , j = - 3 … 3 \qquad ( 9 )$$

For filtering the input image is convoluted with the 2D filter coefficients.

$${I}_{adaptFilter} ( x , y ) = \frac{{\sum }_{i = - 3 … 3} {\sum }_{j = - 3 … 3} Filter ( i , j ) \cdot {X}_{n} ( x + i , y + j )}{{\sum }_{i = - 3 … 3} {\sum }_{j = - 3 … 3} Filter ( i , j )} \qquad ( 10 )$$

The result is the adaptive filter output F. Furthermore the local optimal standard deviations are written to a map which is forwarded so that it can be used for selection of a weighting factor.

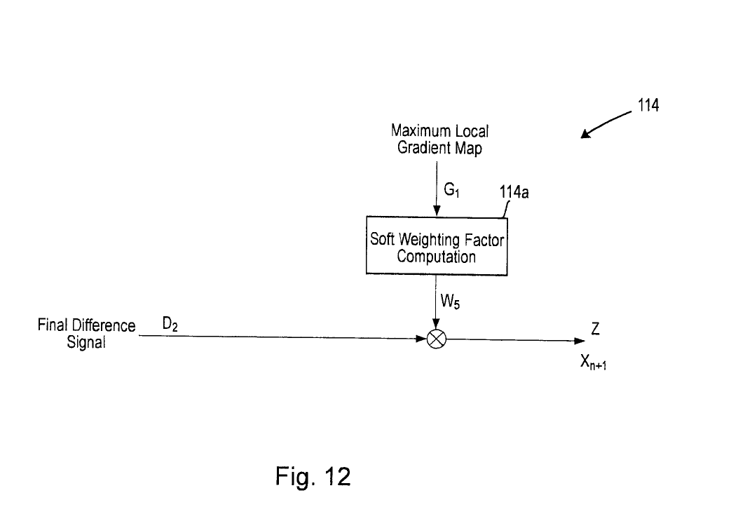

To be able to control the enhancement level of the output signal, a final difference signal between the output of the complete processing and the current input signal is computed in an edge dependent weighting unit 114 as depicted in FIG. 12 in an embodiment. Especially in edge areas the additional detail signal should be limited to control the overenhancement in these areas. Therefore the final difference signal is weighted depending on the maximum local gradient G₁ which indicates the edge strength. The weighting factor W₅ is computed in a soft weighting factor computation unit 114a depending on the thresholds Thr1 and Thr2 using the following function:

$$edgeWeight = \{ \begin{matrix}1 , & max Grad <= Thr 1 \\ 1 - \frac{0.7 \cdot ( max Grad - Thr 1 )}{Thr 2 - Thr 1} & Thr 1 < max Grad < Thr 2 \\ 0.3 , & max Grad \geq Thr 3\end{matrix} \qquad ( 11 )$$

For detail generation from spatially shifted inputs it is preferred to have a sub-pixel accurate compensation of the spatial shifts which are described by motion vectors and disparity vectors. A possible solution is the utilization of a bilinear interpolation. The luminance values of the compensated image are computed as follows:

$${I}_{m c} ( x , y ) = {I}_{prev} ( ⌊ x + {v}_{x} ⌋ , ⌊ y + {v}_{y} ⌋ ) \cdot ( ⌈ x + {v}_{x} ⌉ - ( y + {v}_{x} ) ) \cdot ( ⌈ y + {v}_{y} ⌉ - ( y + {v}_{y} ) ) + {I}_{prev} ( ⌊ x + {v}_{x} ⌋ , ⌈ y + {v}_{y} ⌉ ) \cdot ( ⌈ x + {v}_{x} ⌉ - ( x + {v}_{x} ) ) \cdot ( ( y + {v}_{y} ) - ⌊ y + {v}_{y} ⌋ ) + {I}_{prev} ( ⌈ x + {v}_{x} ⌉ , ⌊ y + {v}_{y} ⌋ ) \cdot ( ( x + {v}_{x} ) - ⌊ x + {v}_{x} ⌋ ) \cdot ( ⌈ y + {v}_{y} ⌉ - ( y + {v}_{y} ) ) + {I}_{prev} ( ⌈ x + {v}_{x} ⌉ , ⌈ y + {v}_{y} ⌉ ) \cdot ( ( x + {v}_{x} ) - ⌊ x + {v}_{x} ⌋ ) \cdot ( ( y + {v}_{y} ) - ⌊ y + {v}_{y} ⌋ ) \qquad ( 12 )$$

vₓ and v_{y} are the sub-pixel accurate motion/disparity vectors. If the accessed image position of the previous result is out of range, the luminance value of the reference input is copied.

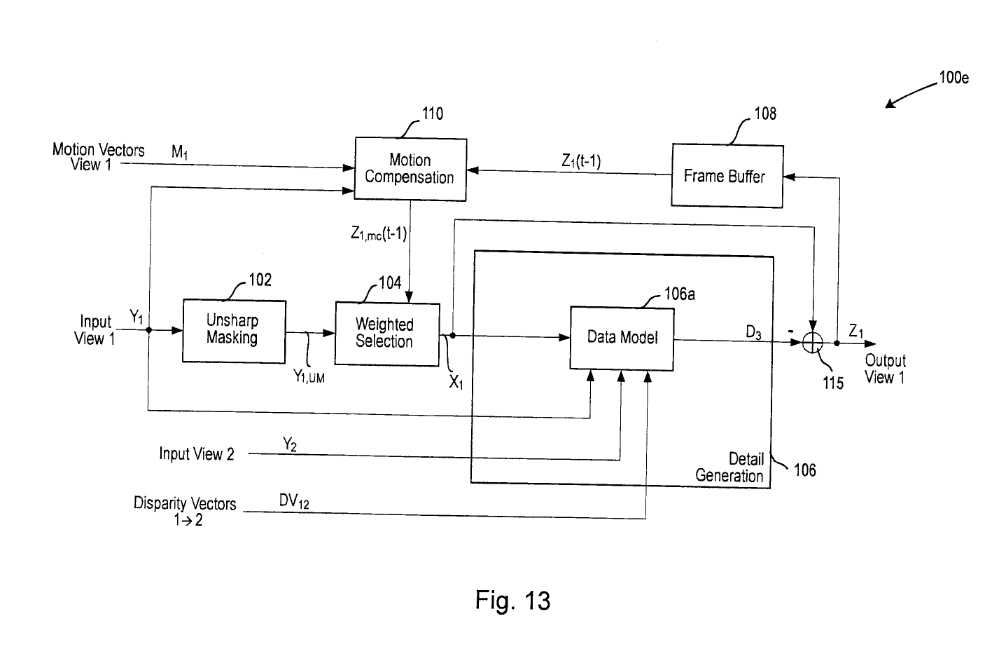

FIG. 13 schematically depicts a further embodiment of the image enhancement apparatus 100e according to the present disclosure for 3D to 2D processing. This embodiment is a low end solution based on the third embodiment 100c. Compared to the third embodiment 100c the detail generation unit 106 is realized using only data model unit 106a for generating a detail signal D₃. In the data model unit 106a the current input frames Y₁ from view 1 and the current input frames Y₂ from view 2 are used to generate the detail signal D₃. Disparity Vectors DV₁₂ are used to compensate the local disparity shifts between Y₁ and Y₂. As no final difference signal is computed and weighted, the final result Z₁ is computed by combining detail signal D₃ and weighted selection image X₁ using combination unit 115′ which, in this embodiment, is realized as a subtraction unit. An internal iteration loop is not realized in this embodiment

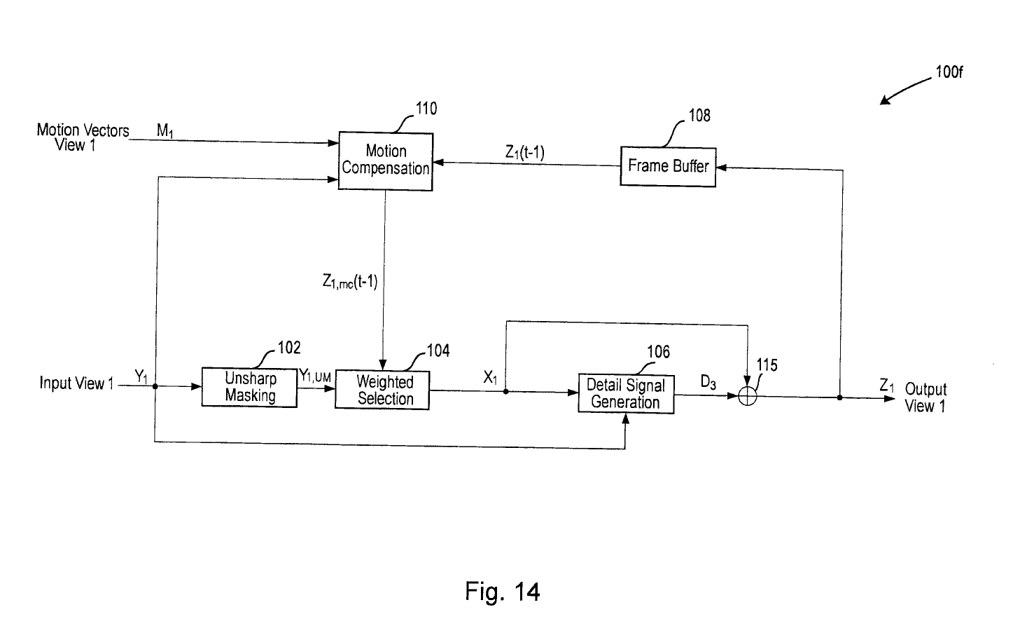

FIG. 14 schematically depicts a sixth embodiment of the image enhancement apparatus 100f according to the present disclosure for 2D to 2D processing. Compared to the first embodiment shown in FIG. 2 in this embodiment the output signal Z₁ is formed in the addition unit 115 by adding the weighted selection image X₁ to the detail signal D₃.

In summary, the present disclosure relates to a method and corresponding apparatus for the enhancement of detail level and sharpness in monoscopic (single view) and stereoscopic image sequences. The detail level is enhanced by temporally accumulating information from multiple input frames of a first view and the additional information obtained from a secondary view of a stereoscopic input sequence using a recursive feedback loop. The accumulation of details results in a higher perceived resolution and sharp-ness in the output sequence. In contrast to typical spatial sharpness enhancement methods like unsharp masking the noise level is not amplified due to temporal and inter-view averaging. Furthermore typical side effects of methods using information from multiple input frames like artifacts from erroneous motion and disparity vectors can be strongly limited. Spatial artifacts are reduced by internally approximating an image model. The proposed method and apparatus is able to handle monoscopic as well as stereoscopic input sequences.

The various elements of the different embodiments of the provided image enhancement apparatus may be implemented as software and/or hardware, e.g. as separate or combined circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit does include the above-described hardware executing software.

Obviously, numerous modifications and variations of the present disclosure are possible in light of the above teachings. It is therefore to be understood that within the scope of the appended claims, the invention may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present invention. Further, such a software may also be distributed in other forms, such as via the Internet or other wired or wireless telecommunication systems.

Any reference signs in the claims should not be construed as limiting the scope.

1. An image enhancement apparatus for enhancing an input image of a sequence of input images of at least a first view and obtaining an enhanced output image of at least said first view, said apparatus comprising:
an unsharp masking unit configured to enhance the sharpness of the input image,
a motion compensation unit configured to generate at least one preceding motion compensated image by compensating motion in a preceding output image,
a weighted selection unit configured to generate a weighted selection image from said sharpness enhanced input image and said preceding motion compensated image based on selection weighting factor,
a detail signal generation unit configured to generate a detail signal from said input image and said weighted selection image, and
a combination unit configured to generate said enhanced output image from said detail signal and from said input image and/or said weighted selection image.

2. The image enhancement apparatus as claimed in claim 1,
further comprising a frame buffer configured to buffer one or more preceding output images for use by said motion compensation unit.

3. The image enhancement apparatus as claimed in claim 1,
wherein said detail signal generation unit comprises a data model unit for generating a first detail signal from said input image and said weighted selection image.

4. The image enhancement apparatus as claimed in claim 3,
wherein said detail signal generation unit comprises an image model unit for generating a second detail signal by approximating an image model to reduce spatial artifacts and noise from said weighted selection image, wherein said first detail signal and said second detail signal are combined into a combined detail signal.

5. The image enhancement apparatus as claimed in claim 4,
further comprising a maximum local gradient unit configured to determine a maximum local gradient in said weighted selection image, wherein said image model unit is configured to use said maximum local gradient to generate said second detail signal.

6. The image enhancement apparatus as claimed in claim 4,
further comprising a first subtraction unit configured to subtract said combined detail signal from said weighted selection image to obtain intermediate signal.

7. The image enhancement apparatus as claimed in claim 6,
further comprising a second subtraction unit configured to subtract the input image from said intermediate signal.

8. The image enhancement apparatus as claimed in claim 7,
further comprising an edge dependent weighting unit configured to weight the third detail signal with an edge strength dependent weighting factor.

9. The image enhancement apparatus as claimed in claim 8,
further comprising a maximum local gradient unit configured to determine a maximum local gradient in said weighted selection image, wherein said edge dependent weighting unit is configured to use said maximum local gradient to generate said edge strength dependent weighting factor.

10. (canceled)

11. The image enhancement apparatus as claimed in claim 1,
wherein said detail signal generation unit is configured to generate said detail signal from said input image of a first view, an input image of a second view, a disparity vector from the first view to the second view and said weighted selection image.

12. The image enhancement apparatus as claimed in claim 1,
wherein said image enhancement apparatus is configured to enhance input images of two sequences of input images of a first view and a second view and obtaining enhanced output images of said first view and said second view,
said image enhancement apparatus comprises
a first image enhancement apparatus as claimed in claim 1 configured to enhance an input image of a sequence of input images of a first view by use of an input image of the first view, and input image of the second view and a disparity vector from the first view to the second view to obtain an enhanced output image of said first view, and
a second image enhancement apparatus as claimed in claim 1 configured to enhance an input image of a sequence of input images of a second view by use of an input image of the first view, and input image of the second view and a disparity vector from the second view to the first view to obtain an enhanced output image of said second view.

13. The image enhancement apparatus as claimed in claim 1,
wherein said unsharp masking unit comprises a low-pass filter configured to filter said input image in two different directions, in particular orthogonal directions, and a subtraction unit configured to subtract the output of said low-pass filter from said input image.

14. The image enhancement apparatus as claimed in claim 13,
wherein said unsharp masking unit further comprises a multiplication unit configured to multiply the output signal of said subtraction unit with a weighting factor and an addition unit configured to add the output signal of said multiplication unit to the input image to obtain a sharpness enhanced input image.

15. The image enhancement apparatus as claimed in claim 1,
wherein said weighted selection unit comprises
an SAD computation unit configured to determine the local summed absolute difference between said sharpness enhanced input image and said preceding motion compensated image,
a flat detection unit configured to determine flat areas in said sharpness enhanced input image and
a weighting factor computation unit configured to determine a selection weighting factor from said local summed absolute difference by use of information obtained by said flat detection unit.

16. The image enhancement apparatus as claimed in claim 4,
wherein said image model unit comprises, for each of two directions, in particular orthogonal directions,
a shift unit configured to shift said weighted selection image by a predetermined number of pixels, in particular by one pixel,
a first subtraction unit configured to subtract the shifted weighted selection image from said unshifted weighted selection image,
a sign operation unit configured to apply a sign operator on the output of said first subtraction unit,
an antishift unit configured to unshift the output of said sign operation unit, and
a second subtraction unit configured to subtract the output of said antishift unit from the output of said sign operation unit, and
wherein said image model unit further comprises an addition unit configured to add the output of said second subtraction units.

17. The image enhancement apparatus as claimed in claim 5,
wherein said maximum local gradient unit comprises
a gradient computation unit configured to determine the gradients of said weighted selection image in two different directions, in particular two orthogonal directions,
an absolute gradient computation unit configured to determine the absolute gradient from said gradients, and
a local maximum gradient computation unit configured to determine the local maximum gradient from said absolute gradient.

18. The image enhancement apparatus as claimed in claim 3,
wherein said data model unit comprises
a low pass filter configured to filter said weighted selection image,
a first subtraction unit configured to subtract said input image from said filtered weighted selection image,
a multiplication unit configured to multiply the output of said subtraction unit with a weighting factor.

19. The image enhancement apparatus as claimed in claim 18,
wherein said data model unit further comprises
a disparity compensation unit configured to compensate disparities in an input image of a second view by use of a disparity vector from the first view to the second view,
a weighted selection unit configured to weight said first image by use of the output of said disparity compensation unit,
a second subtraction unit configured to subtract the output of said weighted selection unit from said filtered weighted selection image, and
an addition unit for adding the outputs of the first and second subtraction units as input to the multiplication unit.

20. An image enhancement method for enhancing an input image of a sequence of input images of at least a first view and obtaining an enhanced output image of at least said first view, said method comprising:
enhancing the sharpness of the input image,
generating at least one preceding motion compensated image by compensating motion in a preceding output image,
generating a weighted selection image from said sharpness enhanced input image and said preceding motion compensated image based on selection weighting factor,
generating a detail signal from said input image and said weighted selection image, and
generating said enhanced output image from said detail signal and from said input image and/or said weighted selection image.

21-23. (canceled)

24. An image enhancement apparatus for enhancing an input image of a sequence of input images of at least a first view and obtaining an enhanced output image of at least said first view, said apparatus comprising:
an unsharp masking means for enhancing the sharpness of the input image,
a motion compensation means for generating at least one preceding motion compensated image by compensating motion in a preceding output image,
a weighted selection means for generating a weighted selection image from said sharpness enhanced input image and said preceding motion compensated image based on selection weighting factor,
a detail signal generation means for generating a detail signal from said input image and said weighted selection image, and
a combination means for generating said enhanced output image from said detail signal and from said input image and/or said weighted selection image.
